(19) United States
(12) Patent Application Publication
(10) Pub. No.: US 2014/0309949 A1
(43) Pub. Date: Oct. 16, 2014

(54) TIME CHART GENERATION APPARATUS, CONTROLLER, DEVICE CONTROL SYSTEM, COMPUTER PROGRAM, COMPUTER READABLE INFORMATION STORAGE MEDIUM

(71) Applicant: KABUSHIKI KAISHA YASKAWA DENKI, Kitakyushu-shi (JP)

(72) Inventor: Takeshi NAGATA, Kitakyushu-shi (JP)

(73) Assignee: KABUSHIKI KAISHA YASKAWA DENKI, Kitakyushu-shi (JP)

(21) Appl. No.: 14/252,718

(22) Filed: Apr. 14, 2014

(30) Foreign Application Priority Data
Apr. 15, 2013 (JP) 2013-085322

(51) Int. Cl. G01M 15/00

(52) U.S. Cl. CPC G01M 15/00
USPC 702/33

(57) ABSTRACT

A time chart generation apparatus includes a user interface, a motor drive shaft chart display, and a motor drive shaft chart generator. The user interface is configured to receive an input from a user. The motor drive shaft chart display is configured to display on an image display device a motor drive shaft chart representing a change in a speed of at least one motor drive shaft along a time axis. The motor drive shaft chart generator is configured to add a movement waveform of the motor drive shaft to the motor drive shaft chart based on a predetermined amount when a first time point on the time axis is designated through the input on the user interface.

### CROSS-REFERENCE TO RELATED APPLICATIONS

The present application claims priority under 35 U.S.C. §119 to Japanese Patent Application No. 2013-085322, filed Apr. 15, 2013. The contents of this application are incorporated herein by reference in their entirety.

### BACKGROUND

1. Field of the Invention

The present invention relates to a time chart generation apparatus, a controller, a device control system, a computer program, and a computer readable information storage medium.

2. Discussion of the Background

Japanese Unexamined Patent Application Publication No. 7-191717 discloses a control program automatic generator that automatically generates a ladder program from a time chart.

Japanese Unexamined Patent Application Publication No. 2003-228403 discloses editing a time chart of an input device and an output device using a personal computer, compiling time chart data into a machine language, and transmitting the compiled machine language to a processing apparatus through an interface.

### SUMMARY

According to one aspect of the present invention, a time chart generation apparatus includes a user interface, a motor drive shaft chart display, and a motor drive shaft chart generator. The user interface is configured to receive an input from a user. The motor drive shaft chart display is configured to display on an image display device a motor drive shaft chart representing a change in a speed of at least one motor drive shaft along a time axis. The motor drive shaft chart generator is configured to add a movement waveform of the motor drive shaft to the motor drive shaft chart based on a predetermined amount when a first time point on the time axis is designated through the input on the user interface.

According to another aspect of the present invention, a controller is configured to control a device based on a time chart generated by the above-described time chart generation apparatus. The device includes a motor drive shaft. The time chart includes the above-described motor drive shaft chart.

According to another aspect of the present invention, a device control system includes the above-described controller and a motor drive shaft. The motor drive shaft is coupled to and controllable by the controller.

According to another aspect of the present invention, a computer program causes a computer to function as a time chart generation apparatus. The time chart generation apparatus includes a user interface, a motor drive shaft chart display, and a motor drive shaft chart generator. The user interface is configured to receive an input from a user. The motor drive shaft chart display is configured to display on an image display device a motor drive shaft chart representing a change in a speed of at least one motor drive shaft along a time axis. The motor drive shaft chart generator is configured to add a movement waveform of the motor drive shaft to the motor drive shaft chart based on a predetermined amount when a first time point on the time axis is designated through the input on the user interface.

According to the other aspect of the present invention, a computer readable information storage medium stores the above-described computer program.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a schematic view of an exemplary device control system including a controller according to an embodiment;

FIG. 2 is a block diagram illustrating a physical configuration of a time chart generation apparatus according to the embodiment;

FIG. 3 is a functional block diagram illustrating the time chart generation apparatus according to the embodiment;

FIG. 4 shows an exemplary time chart generation window on which the time chart generation apparatus is generating a time chart;

FIG. 5 shows an addition of an exemplary new movement waveform to the exemplary time chart generation window;

FIG. 6 shows an exemplary dialog appearing upon designation of a movement waveform on the time chart generation window;

FIG. 7 shows an exemplary dialog appearing upon selection of “Change waveform” on the time chart generation window shown in FIG. 6;

FIG. 8 shows an example of the time chart generation window shown in FIG. 6 at the time when “Reverse waveform” is selected;

FIG. 9 shows an exemplary link resulting from selection of “Link” shown in FIG. 6 and subsequent selection of an input-output chart on the time chart generation window;

FIG. 10 shows an example of the time chart generation window shown in FIG. 6 at the time of selection of “Link” and subsequent selection of the input-output chart when a reverse waveform exists at a 1000-ms time point on the input-output chart;

FIG. 11 shows a state in which the movement waveform has been moved to a 100-ms later time point on the time chart generation window shown in FIG. 10; and

FIG. 12 shows a state in which the reverse waveform has been moved to a 100-ms later time point on the time chart generation window shown in FIG. 10.

### DESCRIPTION OF THE EMBODIMENTS

The embodiments will now be described with reference to the accompanying drawings, wherein like reference numerals designate corresponding or identical elements throughout the various drawings.

Time-based charts refer to representations of how devices operate at which timing against a time axis. A time chart provides a more intuitive grasp of the operation of a device control system than conventional charts such as a ladder chart.

The inventors have developed a time chart generation apparatus that represents an operation of a device control system on a time chart. The inventors also have developed a controller that executes the time chart generated by the time chart generation apparatus to control the device control system. Through the development, the inventors have found that productivity of time chart generation significantly improves if the user interface of the time chart generation apparatus is designed intuitive and simple, taking advantage of the intuitive nature of time charts.

In view of this, the inventors studied and developed the user interface of the time chart generation apparatus in an attempt to significantly improve productivity of time chart generation. As a result, the inventors conceived of a novel and unique time chart generation apparatus and related devices. An embodiment of this time chart generation apparatus and related devices will be described in detail below.

### Device Control System according to Embodiment

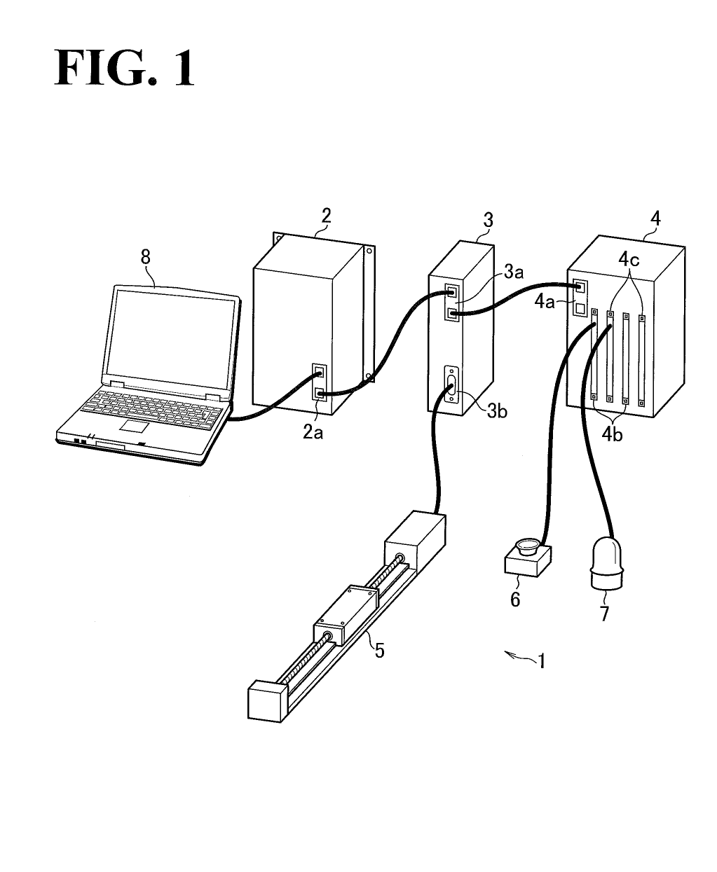

FIG. 1 is a schematic view of an exemplary device control system 1 including a controller 2 according to the embodiment. As shown in FIG. 1, the device control system 1 includes the controller 2, a servo controller 3, an I/O unit 4, a linear slider 5, a switch 6, and a lamp 7. A time chart generation apparatus 8 is coupled to the controller 2.

The controller 2 controls the device control system 1 as a whole. In this embodiment, the controller 2 controls at least device based on a time chart. As used herein, the term “time chart” means information that represents an operation of a device coupled to the controller 2 against a time axis. There is no limitation to the form of the representation. Exemplary control targets of the controller 2 include, but are not limited to, input-output devices such as: motor drive shafts, such as the linear slider 5, that are driven through the servo controller 3; the switch 6; and the lamp 7. The controller 2 executes a time chart generated by the time chart generation apparatus 8. The time chart is input into the controller 2 in the form of electronic data and stored in the controller 2. The controller 2 is provided with an information communication connector 2a.

The servo controller 3 is a combination of a servo amplifier to control a servo motor and a control circuit of the servo amplifier. The servo controller 3 is provided with an information communication connector 3a and a servo connector 3b. The information communication connector 3a provides connection with other devices such as the controller 2. The servo connector 3b provides connection with servo mechanisms such as the linear slider 5. In this embodiment, the servo connector 3b is connected with the linear slider 5, which is an exemplary motor drive shaft.

The linear slider 5 is a combination mechanism of a servo motor, an encoder, ball screws, and a slide table. The ball screws are coupled to the output shafts of the servo motor. The slide table is guided by a linear guide and driven by the ball screws. The slide table is driven in accordance with the output of the servo controller 3. As used herein, the term “motor drive shaft” refers to a mechanism driven by a drive source that is an electric motor, such as the servo motor, capable of controlling the amount of driving. The term motor drive shaft is thus called when the electric motor is in focus. The electric motor may be other than the servo motor; other examples include, but are not limited to, a step motor. Also the electric motor may not necessarily provide rotative power; it is also possible to use a linear motor.

The I/O unit 4 includes an information communication connector 4a and a plurality of input-output contact points. The information communication connector 4a provides connection with other devices such as the controller 2. The plurality of input-output contact points are where input-output devices are connected. The input-output contact points of the I/O unit 4 include input connectors 4b and output connectors 4c. The input connectors 4b include a plurality of contact points for input use (which will be referred to as input contact points), and the output connectors 4c include a plurality of contact points for output use (which will be referred to as output contact points). The I/O unit 4 transmits input states of the input contact points of the input connectors 4b to the controller 2 through the information communication connector 4a. The I/O unit 4 also controls states of the output contact points of the output connectors 4c in accordance with a command transmitted from the controller 2 through the information communication connector 4a. A function of the I/O unit 4 is to add external input-output contact points to the controller 2. In this embodiment, exemplary input-output devices connected to the I/O unit 4 are the switch 6 and the lamp 7. The switch 6 is a mechanical switch of the normally open (that is, contact the point A) type and connected to the input connector 4b. The lamp 7 is connected to the output connector 4c. As used herein, the term “input-output contact point” refers to a contact point at which information is input or output depending on highness or lowness of impedance. The term input-output device refers to a device coupled to the controller 2 at an input-output contact point.

In this embodiment, as shown in FIG. 1, the information communication connectors 2a, 3a, and 4a are connected to each other by means of cascade connection through cables. Thus, the controller 2, the servo controller 3, and the I/O unit 4 are communicable with each other.

The time chart generation apparatus 8 aids a user in generating a time chart to be executed by the controller 2. In this embodiment, the time chart generation apparatus 8 also monitors a state of the device control system 1 by receiving information transmitted from the controller 2. While the time chart generation apparatus 8 may be a dedicated apparatus, the example shown is a general-purpose computer. This computer is implemented as the time chart generation apparatus 8 by executing a computer program to make the computer serve the functions of the time chart generation apparatus 8. The computer program may be stored in any of various light discs or a semiconductor memory such as a computer readable information storage medium, and the computer preferably installs the computer program from the medium. The computer may also download the computer program from any of various information communication networks such as the Internet. The computer program may also be implemented using what is called cloud computing; specifically, the function of the computer program may be provided from a server at a remote place through an information communication network.

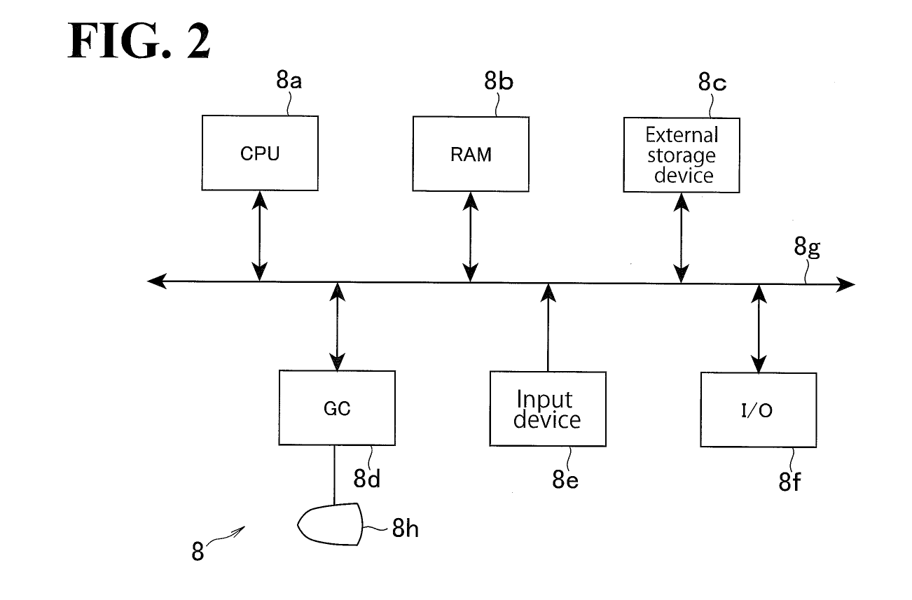

FIG. 2 is a block diagram illustrating a physical configuration of the time chart generation apparatus 8. The time chart generation apparatus 8 is a general-purpose computer, and includes a CPU (Central Processing Unit) 8a, a RAM (Random Access Memory) 8b, an external storage device 8c, a GC (Graphics Controller) 8d, an input device 8e, and an I/O (Input/Output) 8f. The CPU 8a, the RAM 8b, the external storage device 8c, the GC 8d, the input device 8e, and the I/O 8f are connected to each other through a data bus 8g and thus capable of exchanging electrical signals through the data bus 8g. The external storage device 8c is a device that statically records information. Examples include, but are not limited to, an HDD (Hard Disk Drive) and an SSD (Solid State Drive). The GC 8d outputs a signal to a monitor 8h. The monitor 8h displays the signal in the form of an image. The monitor 8h is for the user to visually recognize the image. Examples of the monitor 8h include, but are not limited to, a CRT (Cathode Ray Tube) and what is called a flat panel display. The input device 8e is a device for the user to input information. Examples of the input device 8e include, but are not limited to, a keyboard, a mouse, and a touch panel. The I/O 8f is an interface on which the time chart generation apparatus 8 exchanges information with an external device, which is the controller 2 in this embodiment.

For simplified description and illustration, those configuration details and wiring details irrelevant to understanding of this embodiment are omitted from the above description and FIGS. 1 and 2. For example, a power source line and a ground line are not shown. There is no particular limitation to the form of the connections, the type of the connectors, and the kind and number of the control target devices; any other variations are possible. When the device control system 1 is in operation, the time chart generation apparatus 8 may not necessarily be connected to the controller 2. Insofar as a time chart is transmitted to the controller 2, the device control system 1 is able to operate without the time chart generation apparatus 8. Also the time chart generation apparatus 8 may not necessarily be connected to the controller 2. The time chart generation apparatus 8 alone is able to generate a time chart.

### Configuration of the Time-based Chart Generation Apparatus according to the Embodiment

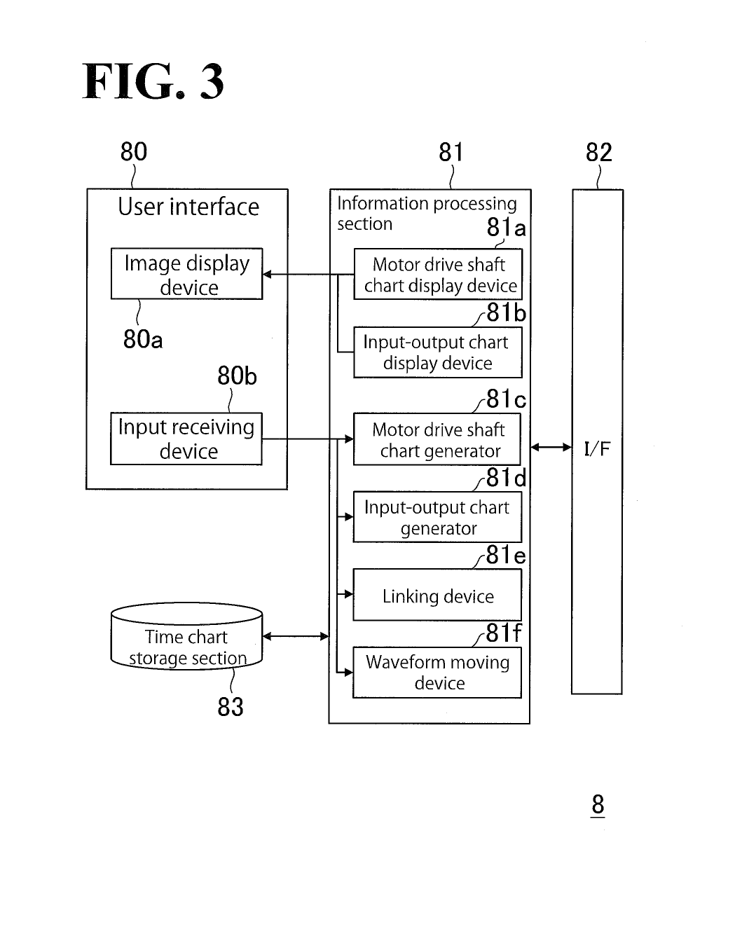

FIG. 3 is a functional block diagram illustrating the time chart generation apparatus 8 according to this embodiment. The time chart generation apparatus 8 includes a user interface 80, an information processing section 81, an interface 82, and a time chart storage section 83.

The user interface 80 shows information to the user and receives information input from the user. The user interface 80 includes an image display device 80a and an input receiving device 80b. The image display device 80a shows information to the user by displaying the information in the form of an image. The input receiving device 80b receives information input from the user. Specifically, the image display device 80a corresponds to, for example, the GC 8d and the monitor 8h shown in FIG. 2. The input receiving device 80b corresponds to, for example, the input device 8e shown in FIG. 2. In particular, in this embodiment, the input device 8e includes what is called a pointing device such as a mouse and a touch panel. With the pointing device, the user is able to make an input by designating coordinates on the image on the image display device 80a.

The information processing section 81 performs various kinds of information processing in the time chart generation apparatus 8. Specifically, the information processing section 81 corresponds to the CPU 8a and the work area RAM 8b shown in FIG. 2. As shown in FIG. 3, the information processing section 81 includes a motor drive shaft chart display device 81a, an input-output chart display device 81b, a motor drive shaft chart generator 81c, an input-output chart generator 81d, a linking device 81e, and a waveform moving device 81f. These elements are schematically shown in FIG. 3 in the form of blocks corresponding to functions contained in information processing implemented by a program that the information processing section 81 executes.

The interface 82 provides electrical communication between the time chart generation apparatus 8 and external devices, and corresponds to the I/O 8f shown in FIG. 2. The time chart storage section 83 stores a time chart that has been generated or is being generated by the time chart generation apparatus 8. Specifically, the time chart storage section 83 uses the external storage device 8c shown in FIG. 2.

For simplified description and illustration, the above-described functional blocks of the time chart generation apparatus 8 are only those functions relevant to understanding of this embodiment, and those functions less relevant are omitted from description. Hence, the time chart generation apparatus 8 may have various other functions in addition to those functions shown in FIG. 3. Where necessary, the following description will refer to FIG. 3, which shows the functional blocks of the time chart generation apparatus 8.

### Operation of the Time-based Chart Generation Apparatus according to the Embodiment

Next, an operation of the time chart generation apparatus 8 according to this embodiment will be described using a specific time chart generation window taken as an example. As described later, the charts that the time chart generation apparatus 8 generates include a motor drive shaft chart and an input-output chart. The motor drive shaft chart and the input-output chart use a common time axis, and the term “time chart” refers to a collective term for the motor drive shaft chart and the input-output chart. These individual motor drive shaft chart and input-output chart included in the time chart will be referred to simply as a chart, or as a motor drive shaft chart or an input-output chart.

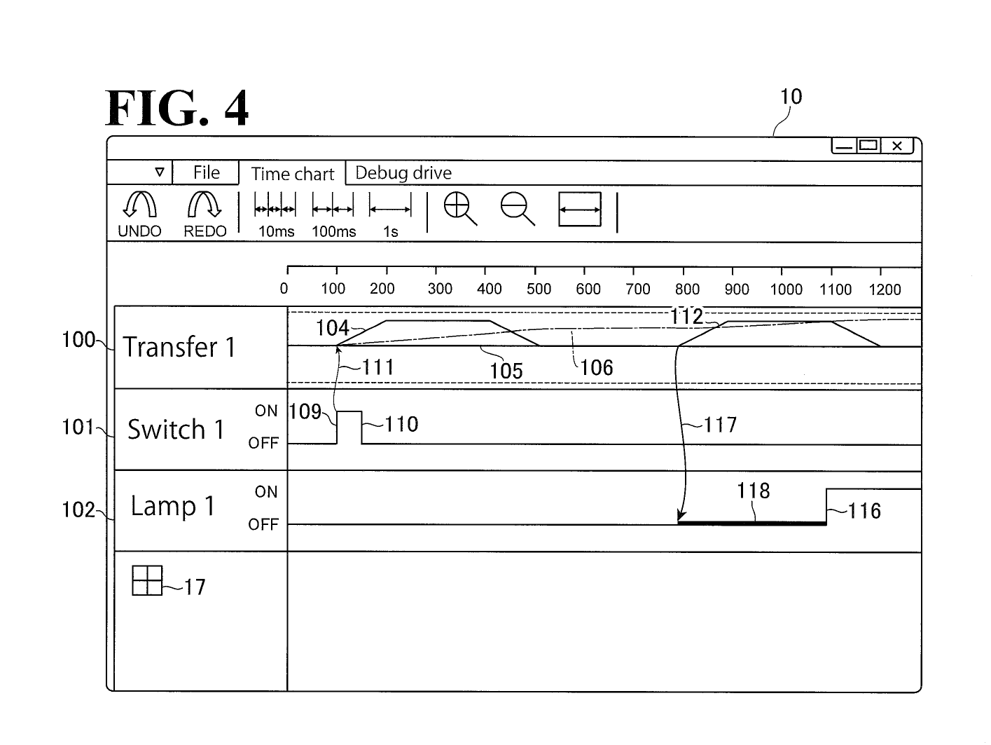

FIG. 4 shows an exemplary time chart generation window on which the time chart generation apparatus 8 is generating a time chart. The time chart generation apparatus 8 is a general-purpose computer using an OS (Operating System) capable of what is called a multi-task and multi-window view. As shown in FIG. 4, an application to cause the computer to function as the time chart generation apparatus 8 is displayed on a window 10. The window 10 described here is an exemplary window that the time chart generation apparatus 8 displays, and any changes in design and layout of the window 10 are possible.

A title area 11 is on the top edge of the window 10. Under the title area 11, an area hereinafter referred to as ribbon 12 is disposed. The ribbon 12 contains icons of various commands available to be designated with respect to the time chart generation apparatus 8. On top of the ribbon 12, a plurality of kinds of tabs are disposed. The ribbon 12 is switchable among the plurality of kinds of tabs, and in each of the tabs, the ribbon 12 provides different kinds of icons. Since FIG. 4 is concerning generation of a time chart, the “time chart” tab is selected in the ribbon 12. Immediately under the ribbon 12, a work area 13 is disposed. The work area 13 is an area where the user receives visual presentations of various kinds of information and makes various specifications. The display details on the work area 13 may be open to change in conjunction with the ribbon 12 being switched. Since in this embodiment the “time chart” tab is designated in the ribbon 12, a time chart that is being generated is shown in the work area 13.

The horizontal axis of the time chart indicates time with a time scale 14 disposed at an upper portion of the time chart. The unit of time on the time scale 14 is millisecond (ms), and each mark on the time scale 14 corresponds to 100 ms. It is possible to change the scale intervals by making a choice in an icon 15 in the ribbon 12. It is also possible to change the scale width by making a choice in an icon 16 or by making a suitable operation with respect to the input receiving device 80b.

Under the time scale 14, charts are displayed corresponding to control target devices. The examples shown in FIG. 4 are three charts, namely, from top to bottom, a motor drive shaft chart 100, an input-output chart 101, and an input-output chart 102.

The “motor drive shaft chart” is a chart that indicates speed change of the motor drive shaft along the time axis. The motor drive shaft chart 100 corresponds to the linear slider 5 shown in FIG. 1. At the left end of the motor drive shaft chart 100, a column 103 shows the device name “Transfer 1”. On the right side of the column 103, a movement waveform 104 is shown along the time scale 14. The movement waveform 104 indicates change of the moving speed of the motor drive shaft, which is the linear slider 5 in this embodiment. Speed is on the vertical axis with a center line 105 indicating speed 0. In FIG. 4, the upward direction indicates the positive side of speed (normal rotation direction of motor), and the downward direction indicates the negative side of speed (reverse rotation direction of motor). As used herein, the term “movement waveform” indicates a speed waveform of a continuous movement of the motor drive shaft. Specifically, in the continuous movement of the motor drive shaft, the motor drive shaft in stationary state is accelerated to start moving and then decelerated into stationary state again. The movement waveform indicates speed change in this continuous movement of the motor drive shaft. If the motor drive shaft repeats moving and stopping a plurality of times, waveforms equal to the number of the repetitions appear on the motor drive shaft chart 100. The exemplary movement waveform 104 shown in FIG. 4 is a trapezoidal waveform indicating a 100-ms acceleration from the 100-ms time point followed by a 200-ms uniform movement, a 100-ms deceleration, and stopping.

Together with the movement waveform 104, a position waveform 106 is shown on the motor drive shaft chart 100. The position waveform 106 indicates position change of the motor drive shaft, which is the slider in this embodiment, with the center line 105 as the origin of the motor drive shaft and the position of the slider on the vertical axis. In FIG. 4, the upward direction indicates the positive side of the position (normal rotation direction of motor), and the downward direction indicates the negative side of the position (reverse rotation direction of motor). To distinguish the movement waveform 104 and the position waveform 106 from each other in FIG. 4, the movement waveform 104 is indicated by a solid line, while the position waveform 106 is indicated by a dashed line. Thus, it is preferable to distinguish the movement waveform 104 and the position waveform 106 from each other on the window by varying the colors or the thicknesses of the lines, other than by varying the kinds of the lines. Here, the position of the origin indicated by the center line 105 may be what is called a machine origin or may be a conveniently determined origin position (what is called a software origin). In this embodiment, the origin position is a position conveniently determined for each individual motor drive shaft.

The items to be shown in the motor drive shaft chart 100 are generated based on items that the motor drive shaft chart display device 81a stores in the time chart storage section 83. The generated items are output to the image display device 80a to be displayed on the image display device 80a. Specifically, the motor drive shaft chart display device 81a displays the motor drive shaft chart 100 on the image display device 80a. The motor drive shaft chart 100 contains the movement waveform 104 and the position waveform 106.

The “input-output chart” is a chart indicating a signal waveform of an input-output device along the time axis. Specifically, the input-output chart indicates a waveform of an input signal from an input device or a waveform of an output signal from an output device along the time axis. The input-output chart 101 corresponds to the switch 6 shown in FIG. 1 as an input device, and the input-output chart 102 corresponds to the lamp 7 shown in FIG. 1 as an output device. At the left end of the input-output chart 101, a column 107 shows the device name “Switch 1”. At the left end of the input-output chart 102, a column 108 shows the device name “Lamp 1”. On the right side of the column 107 and the column 108, signal states of the respective devices are indicated in the form of ON and OFF. Here, ON corresponds to a signal in high state, while OFF corresponds to a signal in low state.

As used in the following description, the term “reverse waveform” refers to a part of the signal waveform shown in the input-output chart and indicates that the signal is reversed at this part. For example, the input-output chart 101 shows that the input signal is reversed from OFF to ON at 100-ms time point, and this part of the input-output chart 101 at 100-ms time point is denoted at reverse waveform 109. The input-output chart 101 also shows that the input signal is reversed from ON to OFF at 150-ms time point, and this part of the input-output chart 101 at 100-ms time point is denoted at reverse waveform 110. In the meantime, the signal shown in the input-output chart 102 remains unchanged, and thus no reverse waveform is shown in the input-output chart 102.

The items to be shown in the input-output chart 101 and the input-output chart 102 are generated based on items that the input-output chart display device 81b stores in the time chart storage section 83. The generated items are output to the image display device 80a to be displayed on the image display device 80a. Specifically, the input-output chart display device 81b displays the input-output chart 101 and the input-output chart 102 on the image display device 80a. The input-output chart 101 contains the reverse waveforms 109 and 110.

The work area 13 also displays a link line 111. The link line 111 is used to link one chart contained in the time chart with another chart contained in the time chart. Thus, the link line 111 indicates that the control target devices operate in conjunction with each other. In the example shown in FIG. 4, the link line 111 is in the form of an arrow extending from the reverse waveform 109 to the beginning of the movement waveform 104. This indicates an operation of making the linear slider 5 start its operation represented by the movement waveform 104 when the input signal from the switch 6 changes from OFF to ON. Thus, the time chart generation apparatus 8 according to this embodiment links a movement waveform to another movement waveform, a reverse waveform to another reverse waveform, or a movement waveform to a reverse waveform, so as to ensure that a predetermined operation of one device triggers an expected operation of another device. The time chart generation apparatus 8 exhibits this control by drawing the link line 111. To clearly distinguish the trigger waveform and the following waveform from each other among the mutually linked waveforms, this link relationship will be hereinafter referred to as “(trigger) waveform-to-(following) waveform link”. Also, this link relationship will be occasionally referred to as “link”. When the link relationship is expressed as “link”, the trigger waveform can be referred to as a link origin waveform, and the following waveform can be referred to as a link destination waveform. In this case, the link relationship can be expressed as, for example, “a link is established from the link origin wavefoim to the link destination waveform”.

In this link relationship, any state change of the trigger (link origin) device may be set as a trigger. In the link relationship represented by the link line 111 shown in FIG. 4, the link origin is an input device and thus the trigger is the reverse waveform 109, which shows an ON-OFF change of the input device. When the link origin is a motor drive shaft, the trigger may be set at a time point on the corresponding waveform at which any state change occurs. Examples of the state change include, but are not limited to, an acceleration start time point, a maximum speed attainment time point (that is, uniform movement start time point), a deceleration start time point, and a stopping time point (that is, positioning completion time point). As described later, this link relationship may not necessarily be a concurrence of the waveform of the following (link destination) device with the trigger state change of the link origin device. It is possible to set a predetermined time difference between the trigger time point and the following time point. More specifically, exemplary processing is to activate a timer upon occurrence of the trigger and to make the waveform of the link destination occur when time is up on the timer.

The arrow indicating the link line 111 forms an S-shaped curve. This is for the purpose of visually distinguishing the link line 111 from operations of devices, which are in many cases indicated using straight lines on a time chart. This manner of indication, however, is provided for descriptive purposes only, and should not be construed in a limiting sense.

An icon 17 is shown under the charts contained in the time chart. When the icon 17 is designated, the time chart generation apparatus 8 adds a new device to be treated in the time chart. More specifically, when the icon 17 is designated, a dialog appears, for example. The dialog makes a request for input of the type (motor drive shaft, input device, or output device) of the device to be added and input of the device name. When the device to be added is a motor drive shaft, various parameters related to the motor drive shaft are input such as maximum speed, acceleration time or acceleration, ball screw pitch, movable range, origin position, and standard displacement. Thus, a motor drive shaft chart or an input-output chart is added to the time chart. The window 10 shown in FIG. 4 shows a state after the icon 17 has been designated three times to add three charts.

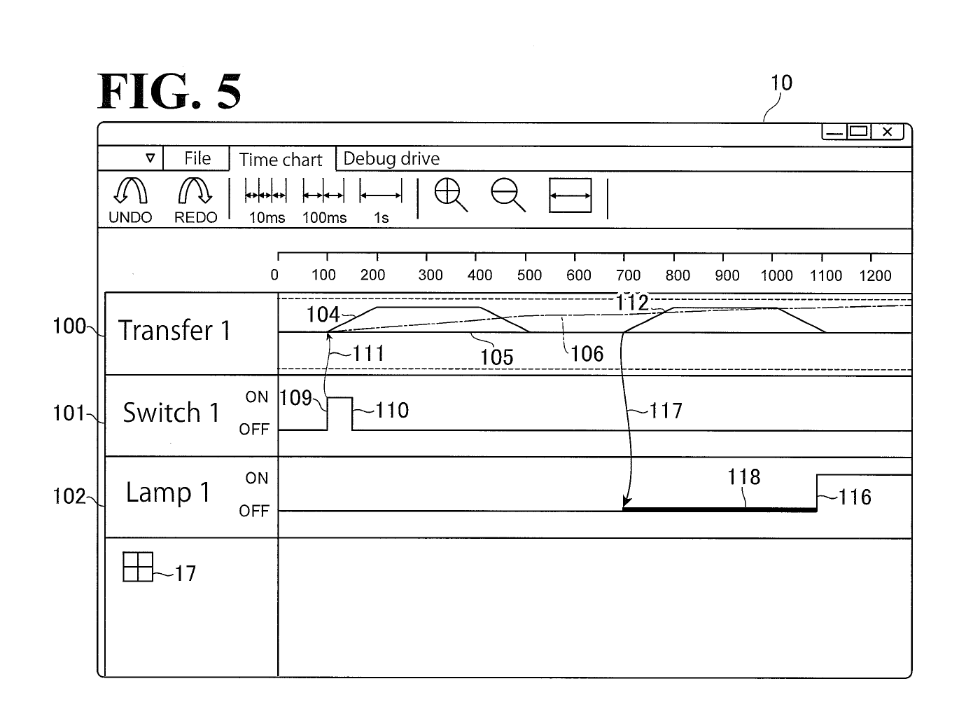

Referring to the state shown in FIG. 4, description will be made with regard to addition of a new movement waveform to the motor drive shaft chart 100 at the 700-ms time point. FIG. 5 shows an addition of a new movement waveform 112 to the time chart generation window. Here, the only operation that the user needs to perform is to designate a time point on the time axis of the motor drive shaft chart 100, that is, a point A in this example, which is positioned at the 700-ms time point on the center line 105. The input receiving device 80b receives the designation, and in response to the designation, the motor drive shaft chart generator 81c adds the movement waveform 112 to the motor drive shaft chart 100 based on a predetermined amount. The motor drive shaft chart display device 81a displays the added movement waveform 112 on the image display device 80a. Here, the predetermined amount that the motor drive shaft chart generator 81c uses indicates information necessary for determining the shape of the movement waveform 112. More specifically, the information includes the displacement, acceleration time or acceleration, and maximum speed of the slider 5.

Thus, retaining a predetermined amount ensures that at the time of adding a movement waveform to the motor drive shaft chart, the only information that needs to be input from the user is the position of the movement waveform on the time axis. This, in turn, ensures that only a simple operation (in this embodiment, designating a time point on the center line 105 by, for example, a one-click operation) is necessary to prompt generation of the movement waveform. As a result, productivity improves in time chart generation. Further in this embodiment, the predetermined amount is defined for each individual motor drive shaft in advance. Specifically, when a plurality of motor drive shafts exist, it is presumed that the capacities, loads, and displacements, which are frequently used, of the motor drive shafts would vary among the motor drive shafts. Hence, retaining predetermined amounts for the motor drive shafts can cause a situation in which a predetermined amount set for one motor drive shaft is applied to another motor drive shaft. This can necessitate a correction every time a movement waveform is generated, resulting in degraded productivity. In view of this, in this embodiment, a predetermined amount is defined for each individual motor drive shaft in advance. This eliminates or minimizes degradation of productivity.

An initial value of the predetermined amount for each individual motor drive shaft may be input from the user upon request, or may be automatically defined. A possible exemplary request for input made to the user is to display a dialog or a similar window at the time when the user designates the icon 17 to add a motor drive shaft chart to the time chart as described above. On the dialog, the user is requested to input the initial value of the predetermined amount, such as standard displacement, acceleration time or acceleration, and maximum speed. When the initial value is automatically defined, it is possible to use a particular rule to determine the standard displacement. For example, a constant factor (for example, 10 times) of the pitch of the feed screw mechanism, such as a ball screw, used in the motor drive shaft may be determined as the standard displacement, or 10% of the movable range (that is, stroke) of the motor drive shaft may be determined as the standard displacement. On the dialog requesting the user for input, an automatically defined predetermined value may be displayed as an initial value.

It is also possible to change the predetermined amount later by the user's operation. The change may be through direct input of a value as a predetermined amount, or as described later, through extraction of a displacement or another parameter from the shape of a movement waveform and setting the extract as a new predetermined amount.

In this example, the user-designated time point (point A) on the time axis of the motor drive shaft chart 100 is the movement start time point of the movement waveform 112. Instead, it is possible to designate the movement end time point of the movement waveform 112. Here, a selection may be made from among the movement start time point, the maximum speed attainment time point, the deceleration start time point, the movement end time point, and any other time point.

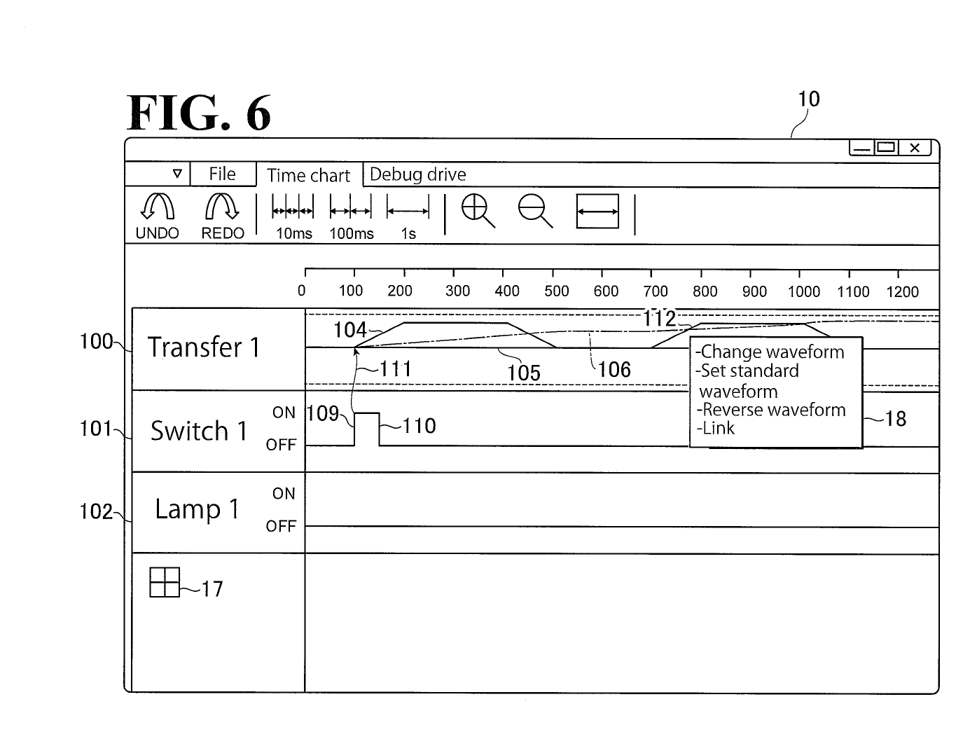

Upon designation of any movement waveform, which may be the movement waveform 112 for example, the motor drive shaft chart generator 81c performs various kinds of processing. FIG. 6 is an exemplary dialog appearing upon designation of the movement waveform 112 on the time chart generation window. As shown in FIG. 6, upon designation of the movement waveform 112, a dialog 18 appears over the window 10 to request designation of processing that the motor drive shaft chart generator 81c is to further perform.

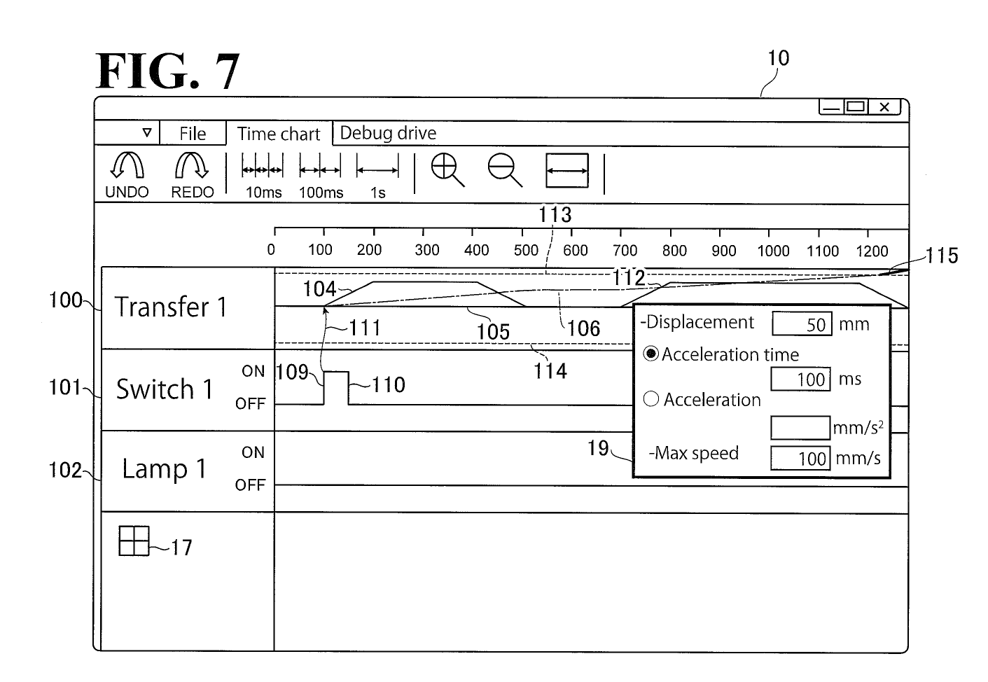

When “Change waveform” is selected on the dialog 18 shown in FIG. 6, the shape of the movement waveform 112 is changed. Specifically, as exemplified in shown in FIG. 7, the motor drive shaft chart generator 81c displays an additional dialog 19 to request the user to input the displacement, acceleration time or acceleration, and maximum speed of the movement waveform 112. Here, the dialog 19 preferably displays the pre-changed displacement, acceleration time or acceleration, and maximum speed of the movement waveform 112. For example, the pre-changed displacement, acceleration time or acceleration, and maximum speed may be set in the respective entry fields in advance as default values. In accordance with the input values, the motor drive shaft chart generator 81c changes the shape of the movement waveform 112. The position waveform 106 is also changed into a corresponding shape.

The dialog 19 shown in FIG. 7 shows a state in which the displacement of the movement waveform 112 has been changed from 30 mm to 50 mm. Accordingly, the constant-velocity drive time of the movement waveform 112 is elongated. In this embodiment, in determining the shape of the movement waveform, the dialog 19 uses radio buttons to select between the acceleration time and the acceleration. Thus, the selection can be made for each individual movement waveform. The selection may also be made for each individual motor drive shaft or for each individual time chart. Also in this embodiment, either a common acceleration time or a common acceleration is used for the acceleration time and deceleration time of the motor drive shaft. It is also possible to set a different acceleration time or a different acceleration between the acceleration time and the deceleration time.

Incidentally, as shown in FIG. 7, the motor drive shaft chart 100 contains, in addition to the position waveform 106, a movable range of the motor drive shaft, which is the linear slider 5 in this case. The movable range includes an upper limit position 113 and a lower limit position 114. In this and other drawings of the present application, the upper limit position 113 and the lower limit position 114 of the movable range are denoted by broken lines. Another possible manner of denoting the movable range is to display the areas outside the movable range outer in gray. Then, when the position of the linear slider 5 exceeds the upper limit position 113 as a result of the change made to the displacement of the movement waveform 112, the position waveform 106 extends beyond the upper limit position 113. Here, the motor drive shaft chart display device 81 a makes a warning indication to inform that the motor drive shaft is in excess of the movable range. An exemplary indication is to call attention visually by displaying the position waveform 106 in a manner different from a normal manner. In this embodiment, a part 115 of the position waveform 106 in excess of the movable range is displayed in red (indicated by a thicker line in FIG. 7).

As used herein, the term “warning indication” refers to an indication that visually or auditorily calls attention of the user. For example, it is possible to display a warning dialog or make a warning sound such as a buzzing sound. Still, it is preferable to visually and intuitively notify the user that the motor drive shaft is in excess of the movable range. In view of this, it is preferable to display the position waveform 106 itself in a manner different from a normal manner, such as changing the color, changing the line type or the thickness, and making an animated indication such as blinking It is more preferable to visually and intuitively notify the user of the time point at which the motor drive shaft exceeds the movable range. As in this embodiment, it is more preferable to display the part 115 of the position waveform 106, which is in excess of the movable range, in a manner different from a normal manner.

Referring back to FIG. 6, when “Set standard waveform” is selected on the dialog 18, the designated movement waveform 112 is set at a standard waveform, that is, the various parameters of the designated movement waveform 112 are set at predetermined amounts. When the movement waveform 112 shown in FIG. 6 is a waveform of, for example, 30 mm displacement, 100 ms acceleration time, and 100 mm/s maximum speed, these amounts are set as new predetermined amounts and used at the time of adding another new movement waveform.

In this respect, in some applications, such a situation is frequently found that an operation of a constant displacement is repeated as an operation of the motor drive shaft. In this case, the work is wasteful if the parameter details of the waveform are input in every operation, and this can degrade productivity in time chart generation. In view of this, once a frequently used movement waveform is generated, this movement waveform may be set as a standard waveform. This significantly facilitates repeated addition of identical movement waveforms. When there are a plurality of kinds of frequently used movement waveforms, it is not necessary to take the labor to input a numerical value of a predetermined amount in accordance with a movement waveform to be added, among the plurality of kinds of frequently used movement waveforms. Instead, by simply setting an existing identical movement waveform as a standard waveform, the predetermined amount is changed significantly simply. This improves productivity in time chart generation. Also, since in this embodiment the predetermined amount can be set for each individual motor drive shaft as described above, the standard waveform can be set for each individual motor drive shaft. Even when each motor drive shaft has a different frequently used waveform, an identical movement waveform can be repeatedly added for each individual motor drive shaft significantly simply. This significantly improves productivity in time chart generation.

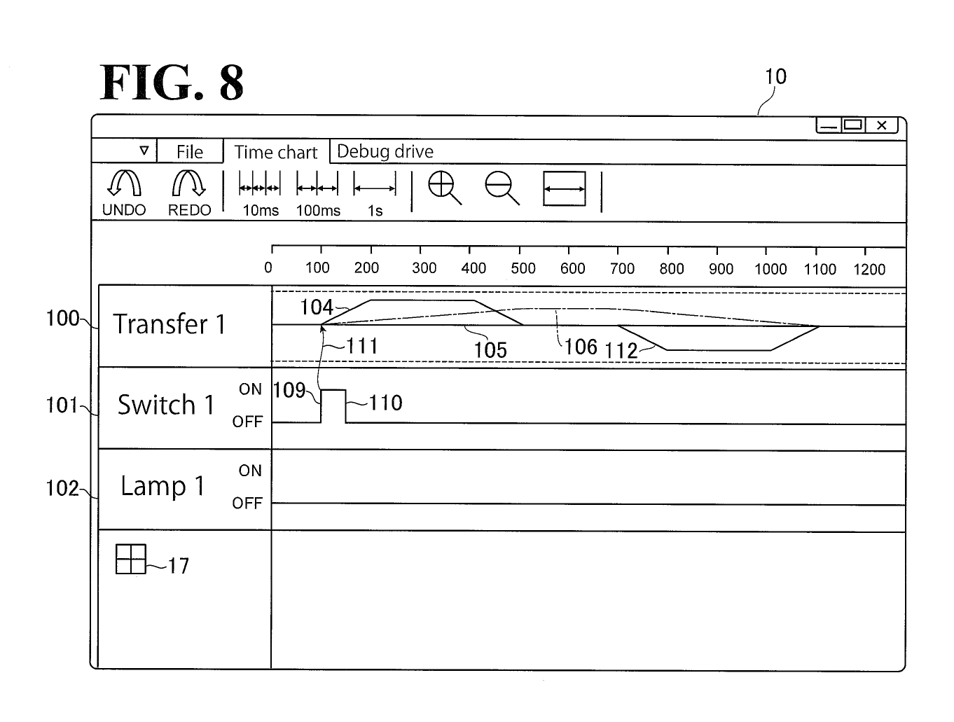

Referring back to FIG. 6, when “Reverse waveform” is selected on the dialog 18, the motor drive shaft chart generator 81c reverses the positivity or negativity of the displacement of the designated movement waveform 112. Specifically, as shown in FIG. 8, the direction in which the movement waveform 112 moves is reversed with the shape of the movement waveform 112 unchanged.

In this respect, such a situation is frequently found that after an operation of the motor drive shaft is performed, the original position before the operation was performed is restored. In this case, an operation opposite to the previous operation, that is, an operation with a reversed direction of movement is performed. Here, the work is wasteful if numerical values of the parameters corresponding to this operation are input and added, and this can degrade productivity in time chart generation. In view of this, when the previous operation is a standard waveform for example, an identical waveform may be added and then the waveform may be reversed. This significantly simplifies addition of an operation opposite to the previous operation. When the previous operation is not a standard waveform, the previous operation may be set as a standard waveform. This similarly significantly simplifies addition of an operation opposite to the previous operation.

Referring back to FIG. 6, when “Link” is selected on the dialog 18, the designated movement waveform 112 is linked to another waveform. The linking device 81e performs this link operation. The link operation varies slightly depending on the chart of the device to be linked. Here, it will be assumed that the link destination device is the lamp 7, which corresponds to the input-output chart 102.

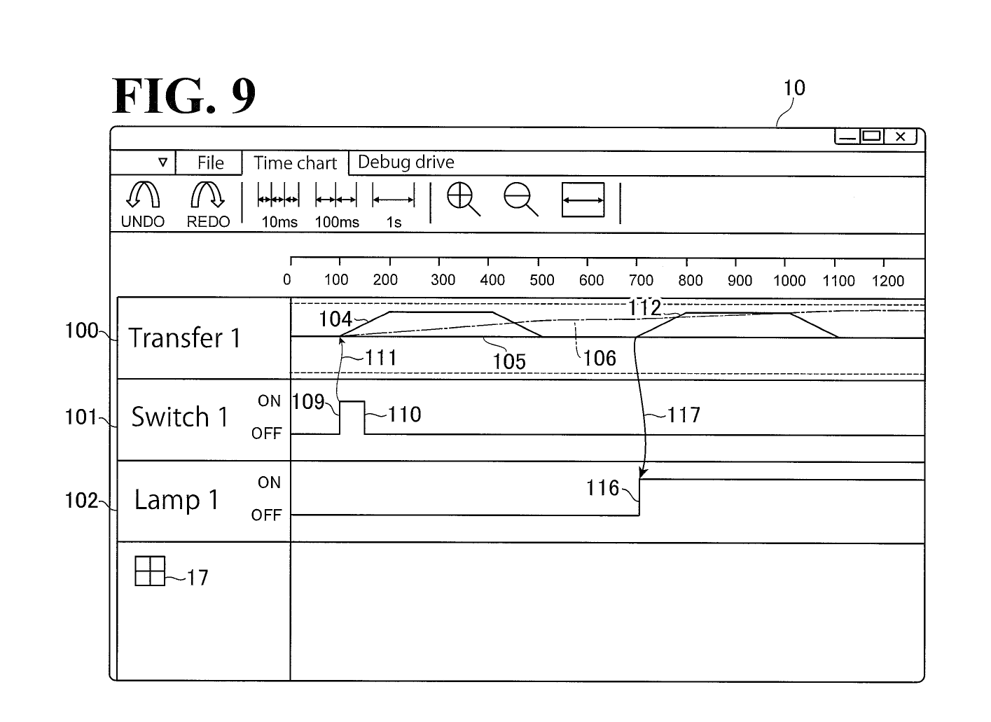

FIG. 9 shows an exemplary link resulting from selection of “Link” shown in FIG. 6 and subsequent selection of the input-output chart 102 on the time chart generation window. Here, a reverse waveform 116 is generated in the input-output chart 102. A link line 117 indicates a link from the movement waveform 112 to the reverse waveform 116.

Here, the linking device 81e performs the following operation. First, at the input-output chart 102, which is now a link destination, the linking device 81e determines presence or absence of the reverse waveform 116 at and later than the time point of the link (in this case, the movement start time point of the movement waveform 112). When the reverse waveform 116 is absent, the linking device 81e generates the reverse waveform 116 at the time point of the link and adds the reverse waveform 116 to the input-output chart 102.

While this example is regarding a link from a motor drive shaft chart to an input-output chart, this should not be construed as limiting the chart types of the link origin and the link destination. Specifically, in an exemplary link from a motor drive shaft chart to another motor drive shaft chart, the link-destination motor drive shaft chart is given a movement waveform that is based on the standard waveform of the shaft, and then a link is established from one movement waveform to another movement waveform. In an exemplary link from an input-output chart to a motor drive shaft chart, the link-destination motor drive shaft chart is similarly given a movement waveform that is based on the standard waveform of the shaft, and then a link is established from one reverse waveform to one movement waveform. In an exemplary link from an input-output chart to another input-output chart, the link-destination input-output chart is given a reverse waveform, and then a link is established from one reverse waveform to another reverse waveform.

In this respect, in establishing a link between an operation of one device and an operation of another device, the work is wasteful if a prerequisite is that waveforms representing the operations of both devices be generated. For example, the work involves an agreement in the timing of both waveforms in generating the waveforms, to the detrimental of intuitive work. This, as a result, can degrade productivity in time chart generation. In view of this, automatic addition of a waveform to the link destination chart saves labor and improves productivity in time chart generation.

FIG. 9 shows an example where the input-output chart 102, which is now a link destination, finds no reverse waveform 116 existing at and later than the time point of the link.

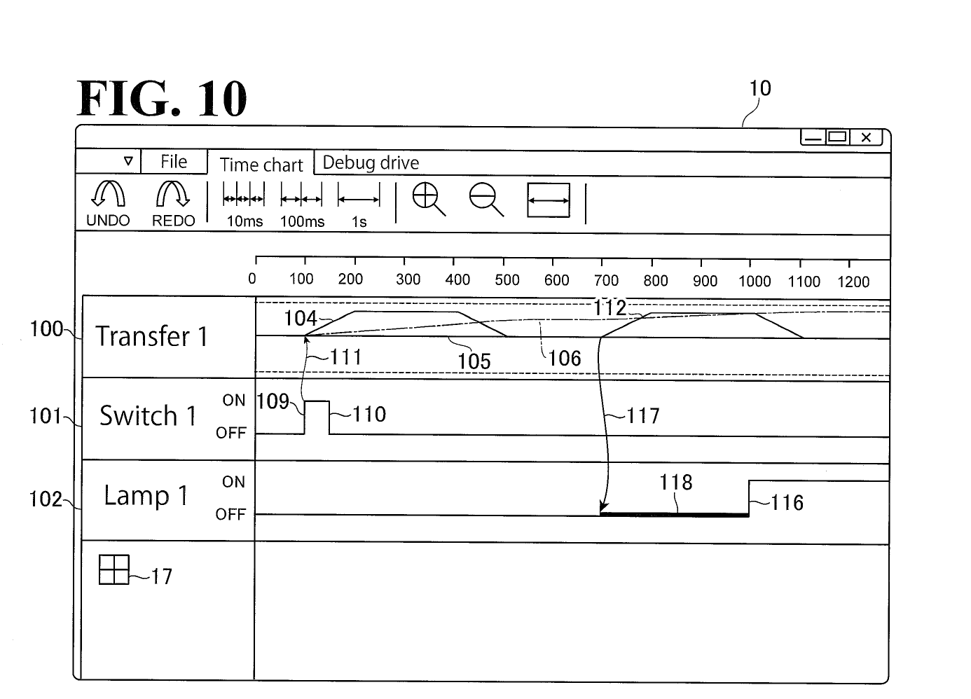

FIG. 10 shows an example where a reverse waveform exists at the 1000-ms time point in the input-output chart 102 shown in FIG. 6, and “Link” is selected and subsequently the input-output chart 102 is selected on the time chart generation window.

Here, the link line 117 is added to the input-output chart 102 at 700 ms, which is the time point of link, to indicate a link from the movement waveform 112 to the input-output chart 102. A timer line 118 is added between the link line 117 and the reverse waveform 116 set at the 1000-ms time point. The timer line 118 indicates a timer of 300 ms. This time chart means that the timer is activated in conjunction with the movement of the slider 5 represented by the movement waveform 112, and upon elapse of 300 ms, the output to the lamp 7 changes from OFF to ON to turn on the lamp 7. The timer line 118 indicates that a timer is set before execution of the waveform immediately after the timer line 118.

Here, the linking device 81e performs the following operation. First, at the input-output chart 102, which is now a link destination, the linking device 81 e determines presence or absence of the reverse waveform 116 at and later than the time point of the link. When the reverse waveform 116 exists, the linking device 81e sets a timer equal to the period of time between the time point of the link and the time point of the reverse waveform 116, and establishes a link from the movement waveform 112 to the reverse waveform 116. This example should not be construed as limiting the link to a link from a motor drive shaft chart to an input-output chart. It is also possible to establish a link from a motor drive shaft chart to another motor drive shaft chart, a link from an input-output chart to a motor drive shaft chart, and a link from an input-output chart to another input-output chart.

In this respect, in describing an operation of one device and an operation of another device in conjunction with the operation of the one device with a predetermined time delay, the work is laborious if a prerequisite is that waveforms of all the devices and timers indicating all the time delays be generated. For example, the work involves backward calculation of the time difference between the waveforms to be linked together in setting a timer. This, as a result, can degrade productivity in time chart generation. In view of this, automatic addition of a timer to the link destination chart saves labor and improves productivity in time chart generation.

Additionally, the time chart generation apparatus 8 ensures that the position of at least one of the waveforms contained in each chart, namely, the movement waveform and the reverse waveform, can be moved on the time axis simply and intuitively. The waveform moving device 81f performs this movement when the user selects a waveform to move through the input receiving device 80b and performs a moving operation, such as what is called a dragging operation, of the selected waveform along the time axis. Here, little concern is expected when the waveform to move has no link, whereas when the waveform to move is linked to another waveform, a concern arises as to how to perform the processing of movement.

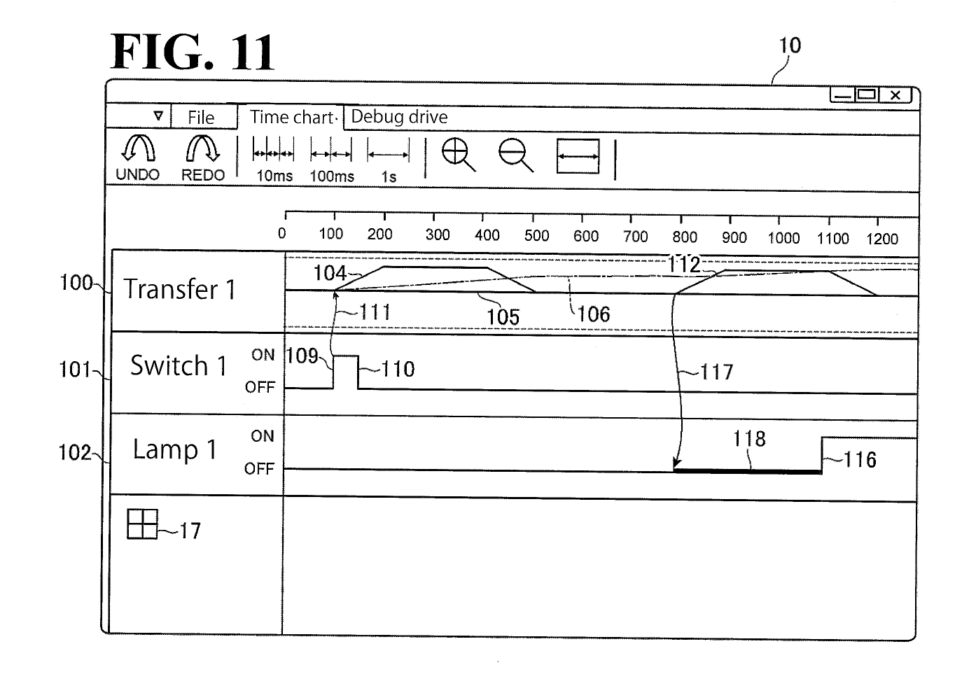

FIG. 11 shows a state in which the movement waveform 112 has been moved to a 100-ms later time point on the time chart generation window shown in FIG. 10. Specifically, FIG. 11 shows the window 10 as a result of the user's dragging operation of the movement waveform 112 shown in FIG. 10 to the right by one mark on the time scale. In this case, as shown in FIG. 11, the timer line 118 and the reverse waveform 116, which are now linked from the movement waveform 112, are moved by the same time (100 ms) in conjunction with the movement of the movement waveform 112.

Here, the waveform moving device 81f performs the following operation. When a link is established from the waveform on the move to another waveform, the waveform moving device 81f moves the other waveform in conjunction with the waveform on the move.

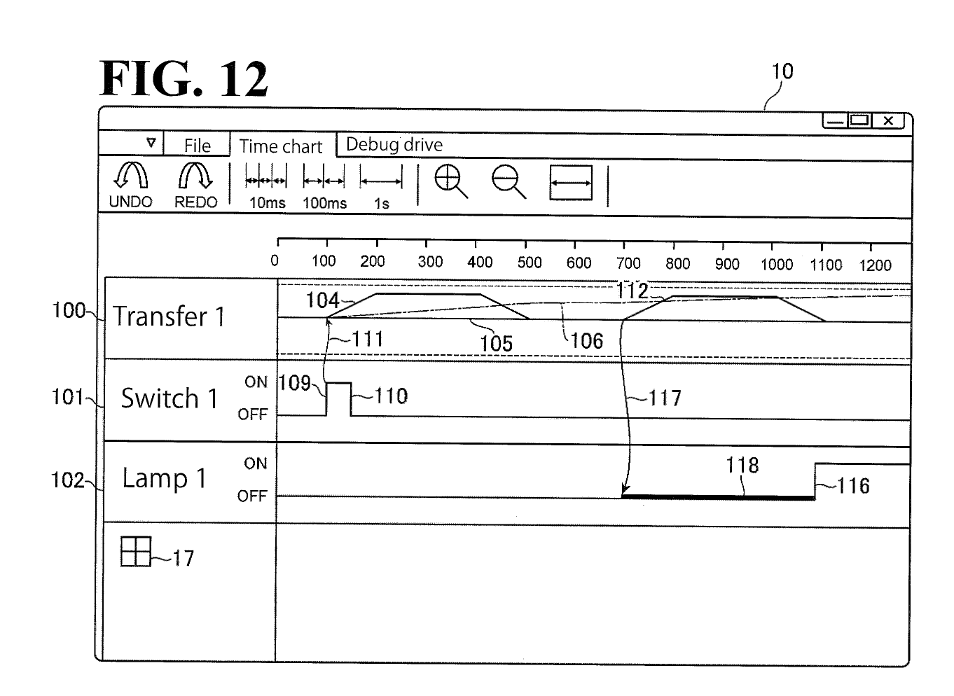

FIG. 12 shows a state in which the reverse waveform 116 has been moved to a 100-ms later time point on the time chart generation window shown in FIG. 10. Specifically, FIG. 12 shows the window 10 as a result of the user's dragging operation of the reverse waveform 116 shown in FIG. 10 to the right by one mark on the time scale. In this case, as shown in FIG. 12, the movement waveform 112 remains changed, while the reverse waveform 116 is moved to the 1100-ms time point, which is 100 ms later. Accordingly, the period of time indicated by the timer line 118 increases to 400 ms.

Here, the waveform moving device 81f performs the following operation. When a link is established to the waveform on the move from another waveform, the waveform moving device 81f increases or decreases the period of time on the timer set on the waveform on the move by a period of time equal to the displacement. When no timer is set on the waveform on the move, a timer is set. In this case, considering that the time on the timer is 0 in the first place, the waveform moving device 81f can be thought of as increasing the time on the timer. It is noted that a movement to make the time negative is prohibited.

This ensures that a waveform linked with another waveform is moved simply and intuitively with no or minimal contradictions in the time set on the timer or in the link relationship.

In the foregoing description, the processing that the motor drive shaft chart generator 81c performs upon designation of any waveform is based on the user's selection of one piece of processing on the dialog 18 shown in FIG. 6. The user's selection of one piece of processing may not necessarily be made on the window, by selecting among the processings listed on the dialog 18.

Specifically, it is possible to assign in advance a particular operation member to each one of the pro cessings that the motor drive shaft chart generator 81c performs, and to perform a piece of processing immediately after the user operates a particular operation member corresponding to the piece of processing. Examples of the operation member include, but are not limited to, a keyboard of the time chart generation apparatus 8, which is a general-purpose computer. In this case, it is preferable to select keys to be assigned to the processings from those keys within reach of one hand. For example, in the case of the left hand operating the keyboard with the right hand operating a mouse, which is a pointing device, the keys to be assigned to the processings are preferably selected from those keys on the left side of the keyboard. In a keyboard with the standard QWERTY arrangement, “E” may be assigned to waveform change, “Q” may be assigned to setting of standard waveform, “W” may be assigned to reverse waveform, and “R” may be assigned to link

Thus, the operation member is preferably assigned under the assumption that the user operates the pointing device with one hand and the operation member with the other hand. This ensures that after selecting a waveform using the pointing device, it is not necessary to further move the pointing device when causing the motor drive shaft chart generator 81c to perform processing. This, in turn, ensures a swift operation and improves productivity in time chart generation.

Through the above-described operations, the time chart generation apparatus 8 generates the time chart generated based on input from the user, and transmits the generated time chart as electronic information to the controller 2 through the interface 82. The controller 2 controls each device based on the transmitted time chart. In this embodiment, the time chart that the time chart generation apparatus 8 transmits to the controller 2 contains information that is not used when the controller 2 controls each device. For example, even though the predetermined amount defined for each individual motor drive shaft is not used by the controller 2, the predetermined amount is contained in the time chart transmitted to the controller 2.

This is for the purpose of eliminating a lack of any piece of information relevant to time chart generation on such a reversed occasion that a time chart transmitted to and stored in the controller 2 as electronic information is downloaded into the time chart generation apparatus 8 to be amended. It is also possible to keep the information not used by the controller 2 within the time chart generation apparatus 8, instead of transmitting the information to the controller 2. This is advantageous in that the amount of the electronic information of the time chart transmitted to the controller 2 is reduced.

Obviously, numerous modifications and variations of the present invention are possible in light of the above teachings. It is therefore to be understood that within the scope of the appended claims, the present disclosure may be practiced otherwise than as specifically described herein.

What is claimed as new and desired to be secured by Letters Patent of the United States is:

1. A time chart generation apparatus comprising:
a user interface configured to receive an input from a user;
a motor drive shaft chart display configured to display on an image display device a motor drive shaft chart representing a change in a speed of at least one motor drive shaft along a time axis; and
a motor drive shaft chart generator configured to add a movement waveform of the motor drive shaft to the motor drive shaft chart based on a predetermined amount when a first time point on the time axis is designated through the input on the user interface.

2. The time chart generation apparatus according to claim 1, wherein the predetermined amount is retained for each one motor drive shaft of the at least one motor drive shaft.

3. The time chart generation apparatus according to claim 1, wherein the motor drive shaft chart generator is configured to update the predetermined amount based on the movement waveform when the movement waveform is selected through the input on the user interface.

4. The time chart generation apparatus according to claim 1, wherein the motor drive shaft chart generator is configured to reverse a direction in which the movement waveform moves when the movement waveform is selected through the input on the user interface.

5. The time chart generation apparatus according to claim 1, wherein the motor drive shaft chart display is configured to display on the motor drive shaft chart a position waveform of the at least one motor drive shaft along the time axis and a movable range of the at least one motor drive shaft, and
wherein when a position of the at least one motor drive shaft is outside the movable range, the motor drive shaft chart display is configured to display a warning indication.

6. The time chart generation apparatus according to claim 1, further comprising:
an input-output chart display configured to display on the image display device an input-output chart along the time axis, the input-output chart indicating a signal waveform of an input-output device;
an input-output chart generator configured to add a reverse waveform to the input-output chart when a second time point on the time axis is designated through the input on the user interface, the reverse waveform indicating that a signal of the input-output device is reversed; and
a linking device configured to perform a linking operation when at least one waveform is selected from among the movement waveform and the reverse waveform through the input on the user interface and when the motor drive shaft chart or the input-output chart is selected to be linked to the selected movement waveform or the selected reverse waveform, the linking device being configured to add a movement waveform based on the predetermined amount to the selected motor drive shaft chart or add a reverse waveform based on the predetermined amount to the selected input-output chart.

7. The time chart generation apparatus according to claim 6, wherein when another movement waveform exists in the selected motor drive shaft chart or when another reverse waveform exists in the selected input-output chart at a third time point later than the first time point and the second time point at which the selected movement waveform and the selected reverse waveform were selected, the linking device is configured to set a timer on the other movement waveform or the other reverse waveform so as to link the other movement
waveform to the selected movement waveform or link the other reverse waveform to the selected reverse waveform.

8. The time chart generation apparatus according to claim 6, further comprising a waveform moving device,
wherein when at least one waveform is selected from among the movement waveform and the reverse waveform and is subjected to a moving operation along the time axis through the input on the user interface, and if as a result of the moving operation the selected movement waveform is linked to another movement waveform or the selected reverse waveform is linked to another reverse waveform, the waveform moving device is configured to move the other movement waveform in conjunction with the selected movement waveform or move the other reverse waveform in conjunction with the selected reverse waveform, and
wherein if as a result of the moving operation the other movement waveform is linked to the selected movement waveform or the other reverse waveform is linked to the selected reverse waveform, the waveform moving device is configured to change a time on a timer set in the selected movement waveform or in the selected reverse waveform.

9. A controller configured to control a device based on a time chart generated by the time chart generation apparatus according to claim 1, the device comprising a motor drive shaft, the time chart comprising the motor drive shaft chart.

10. A device control system comprising:
the controller according to claim 9; and
a motor drive shaft coupled to and controllable by the controller.

11. A computer program causing a computer to function as a time chart generation apparatus, the time chart generation apparatus comprising:
a user interface configured to receive an input from a user;
a motor drive shaft chart display configured to display on an image display device a motor drive shaft chart representing a change in a speed of at least one motor drive shaft along a time axis; and
a motor drive shaft chart generator configured to add a movement waveform of the motor drive shaft to the motor drive shaft chart based on a predetermined amount when a first time point on the time axis is designated through the input on the user interface.

12. A computer readable information storage medium storing the computer program according to claim 11.

13. The time chart generation apparatus according to claim 2, wherein the motor drive shaft chart generator is configured to update the predetermined amount based on the waveform when the waveform is selected through the input on the user interface.

14. The time chart generation apparatus according to claim 2, wherein the motor drive shaft chart generator is configured to reverse a direction in which the waveform moves when the waveform is selected through the input on the user interface.

15. The time chart generation apparatus according to claim 3, wherein the motor drive shaft chart generator is configured to reverse a direction in which the waveform moves when the waveform is selected through the input on the user interface.

16. The time chart generation apparatus according to claim 13, wherein the motor drive shaft chart generator is configured to reverse a direction in which the waveform moves when the waveform is selected through the input on the user interface.

17. The time chart generation apparatus according to claim 2,
wherein the motor drive shaft chart display is configured to display on the motor drive shaft chart a position waveform of the at least one motor drive shaft along the time axis and a movable range of the at least one motor drive shaft, and
wherein when a position of the at least one motor drive shaft is outside the movable range, the motor drive shaft chart display is configured to display a warning indication.

18. The time chart generation apparatus according to claim 3,
wherein the motor drive shaft chart display is configured to display on the motor drive shaft chart a position waveform of the at least one motor drive shaft along the time axis and a movable range of the at least one motor drive shaft, and
wherein when a position of the at least one motor drive shaft is outside the movable range, the motor drive shaft chart display is configured to display a warning indication.

19. The time chart generation apparatus according to claim 4,
wherein the motor drive shaft chart display is configured to display on the motor drive shaft chart a position waveform of the at least one motor drive shaft along the time axis and a movable range of the at least one motor drive shaft, and
wherein when a position of the at least one motor drive shaft is outside the movable range, the motor drive shaft chart display is configured to display a warning indication.

20. The time chart generation apparatus according to claim 13,
wherein the motor drive shaft chart display is configured to display on the motor drive shaft chart a position waveform of the at least one motor drive shaft along the time axis and a movable range of the at least one motor drive shaft, and
wherein when a position of the at least one motor drive shaft is outside the movable range, the motor drive shaft chart display is configured to display a warning indication.
